(19) United States
(12) Patent Application Publication
(10) Pub. No.: US 2011/0255940 A1
(43) Pub. Date: Oct. 20, 2011

(54) Cartridge-type-loading transit case system and method for loading electronic racks in a receiver rack

(76) Inventor: Jeffrey T. Wildfeuer, Salem, NH (US)

(21) Appl. No.: 12/799,180

(22) Filed: Apr. 20, 2010

(51) Int. Cl. B65G 1/00

(52) U.S. Cl. 414/267; 414/807

(57) ABSTRACT

A cartridge-type-loading transit case system and method for loading electronic racks in a receiver rack aligning a front side of the transit case with a modular slot of the receiver rack and sliding a slidable sliding rack out of the transit case into the modular slot by exerting a force from a rear slide of the transit case.

### GOVERNMENT RIGHTS

This application was made with U.S. Government support under Contract No. W31P4Q-08-C-0419 Command Post Trade Study. The Government may have certain rights under the subject invention.

### FIELD OF THE INVENTION

This invention relates to a cartridge-type-loading transit case system and method for loading electronic racks into a receiver rack.

### BACKGROUND OF THE INVENTION

Conventional electronic components in military applications are transported in transit cases. The transit cases include a fixed rack mounted within the transit case on shock mounts using rubber or springs. Some transit cases feature a sliding rack. The sliding rack is a rack which is slidably received in the fixed rack from the front of the transit case. The transit case typically has a front and back covers for access to the sliding rack when it is mounted in the transit case. But the sliding rack only slides out of the transit case through the front. In use the sliding rack is loaded with one or more components, then slid into the fixed rack through the front of the transit case after which the front and back covers are attached and the transit case is transported to its destination. At the destination, the sliding rack can be removed and mounted into a fixed receiver rack. Presently this is done by removing the sliding rack through the front of the transit case, then lifting it, and holding at the proper height and aligning it with the designated slot of a bay of the receiver rack, then sliding it in and fastening it in place. Often these sliding rack modules exceed single man-lift limits and may require three or even four soldiers to lift, carry and align it for entry into the receiver rack. The spaces where the receiver racks are located are often small and cramped making it difficult sometimes for even one soldier to maneuver with such a rack and introducing the risk of injury to equipment and personnel.

### SUMMARY OF THE INVENTION

In accordance with various aspects of the subject invention, in at least one embodiment there is a cartridge-type-loading transit case system compatible with sliding rack-transit case design that provides a quicker and easier approach to install a sliding rack from transit case to ultimate receiver rack which is safer for personnel and equipment.

The improved cartridge-type-loading transit case system and method, in various aspects, can be achieved with a transit case, a fixed rack mounted in the transit case, and a sliding rack bi-directionally slidable in forward and back directions in the fixed rack for engaging a receiver rack into which the sliding rack is to be back loaded from the transit case.

The subject invention, however, in other embodiments, need not achieve all these objectives and the claims hereof should not be limited to structures or methods capable of achieving these objectives.

In one embodiment a cartridge-type-loading transit case system for loading electronic racks in a receiver rack includes a transit case, a fixed rack mounted in the transit case, and a sliding rack bi-directionally slidable in forward and back directions in the fixed rack for engaging a receiver rack into which the sliding rack is to be back loaded from the transit case.

In another embodiment a cartridge-type-loading transit case system for loading electronic racks in a receiver rack includes a transit case, a fixed rack mounted in the transit case, a sliding rack bi-directionally slidable in forward and back directions in the fixed rack, and a receiver rack for receiving the sliding rack as loaded from the transit case.

In preferred embodiments there may be at least one guide member for engaging a receiver rack. At least one guide member may be mounted on the transit case. At least one guide member may include a pin on one of the transit case and receiver rack and a hole on the other. There may be a stop member for constraining sliding movement of the sliding rack in the transit case. There may be stop members at the back and front of the transit case. The stop members may be mounted on the transit case. The transit case may include a lifting device for raising it to the proper height and alignment with the receiver rack. The lifting device can be configured for use with a simple machine, such as a pulley.

Another embodiment involves a method of loading an electronic rack stored in a transit case into a receiver rack. A front side of the transit case is aligned with a modular slot of the receiver rack and a slidable sliding rack is slid out of the transit case and into the modular slot by exerting a force from a rear side of the transit case where the rear side is opposite the front side.

The lifting of the transit case may employ a lifting device such as a simple machine. Aligning may be achieved by aligning an alignment pin with an alignment hole.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional schematic diagrammatic view of a transit case system according to one embodiment disposed for cartridge type loading to a receiver rack;

FIG. 2 is a three dimensional view of the transit case system of FIG. 1 in more detail;

FIG. 3 is a rear plan view of the transit case system of FIG. 2;

FIG. 4 is a three dimensional schematic view of the sliding action of the sliding rack into the front and out of the back of the fixed rack of FIGS. 2 and 3;

FIG. 5 is a more detailed, three dimensional view of slide brackets shown in FIG. 1; and

FIGS. 6 and 7 taken with FIG. 1 depict the cartridge type loading method effected with the transit case system of this embodiment.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

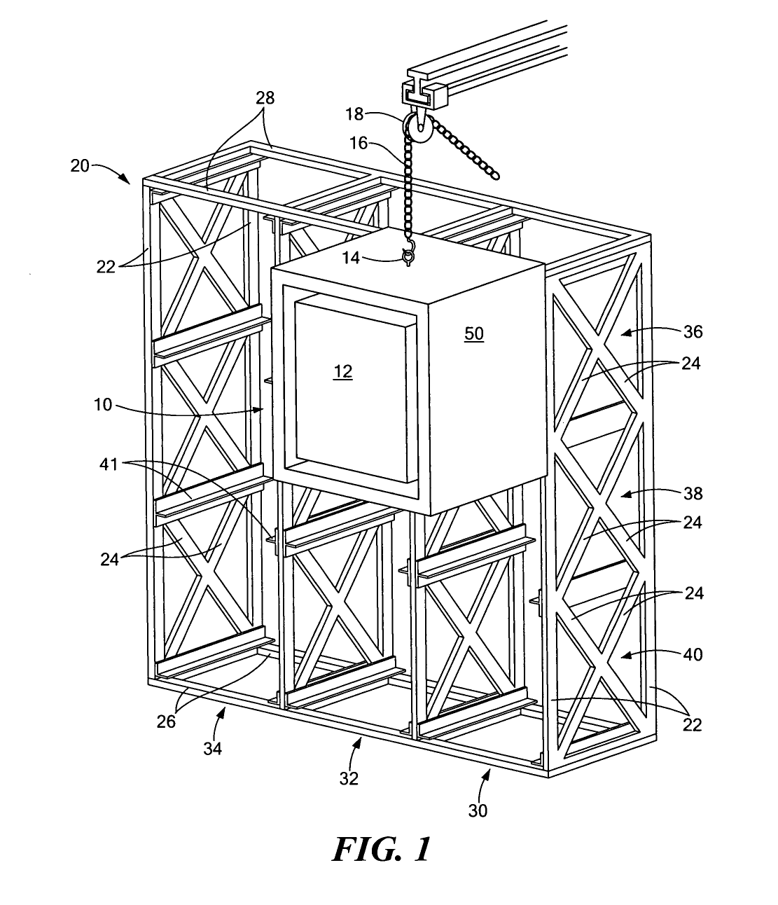

There is shown in FIG. 1 a transit case system 10 according to this invention containing an electronic module 12 on a sliding rack. Transit case system 10 includes a lifting device 14 such as an “eye” which can be attached through chain 16 to a chain hoist or similar device 18 to lift transit case system 10 to the proper slot and bay of receiver rack 20. Receiver rack 20 is formed of a plurality of vertical supports 22 reinforced by cross bracing 24 and tied together by base ties 26 and head ties 28 to form three bays 30, 32, and 34 each of which as exemplified by bay 30 has three modular slots 36, 38 and 40 each of which is adapted to receive a common rack module such as a common 19 inch rack module. Each slot of each bay is provided with slide brackets 41 two at the bottom and two at the top of each slot for receiving module 12 in the cartridge-type-loading operation. In FIG. 1 transit case system 10 has been raised and aligned to the proper position with the top slot 36 in the right hand bay 30 to allow sliding rack module 12 to be inserted in a cartridge type loading motion out the back of transit case 50 and into bay 36.

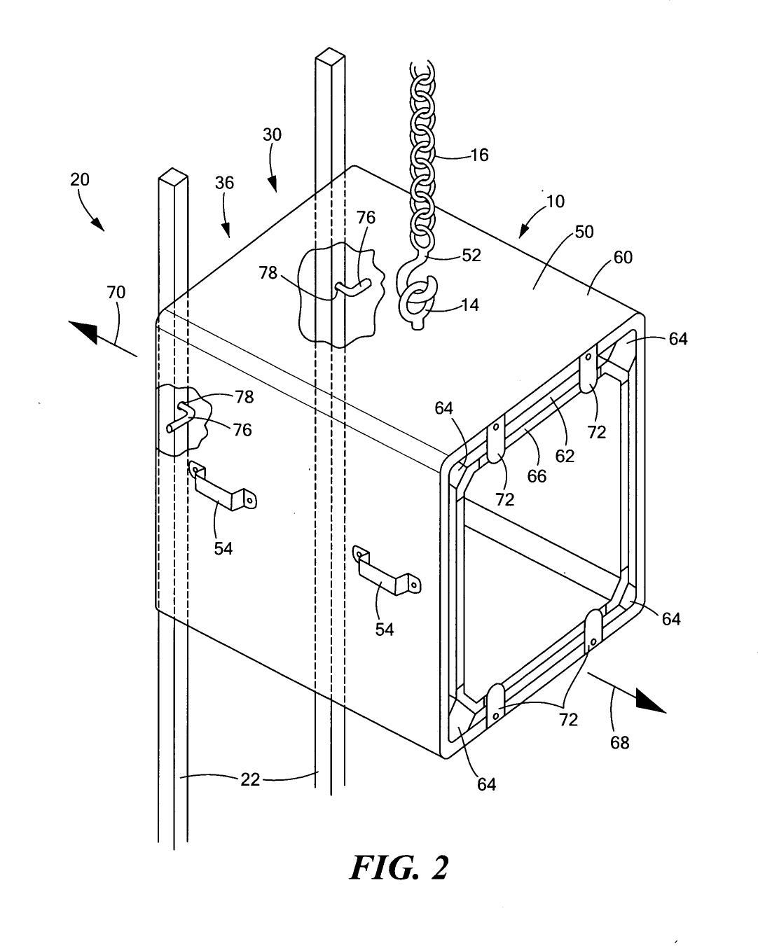

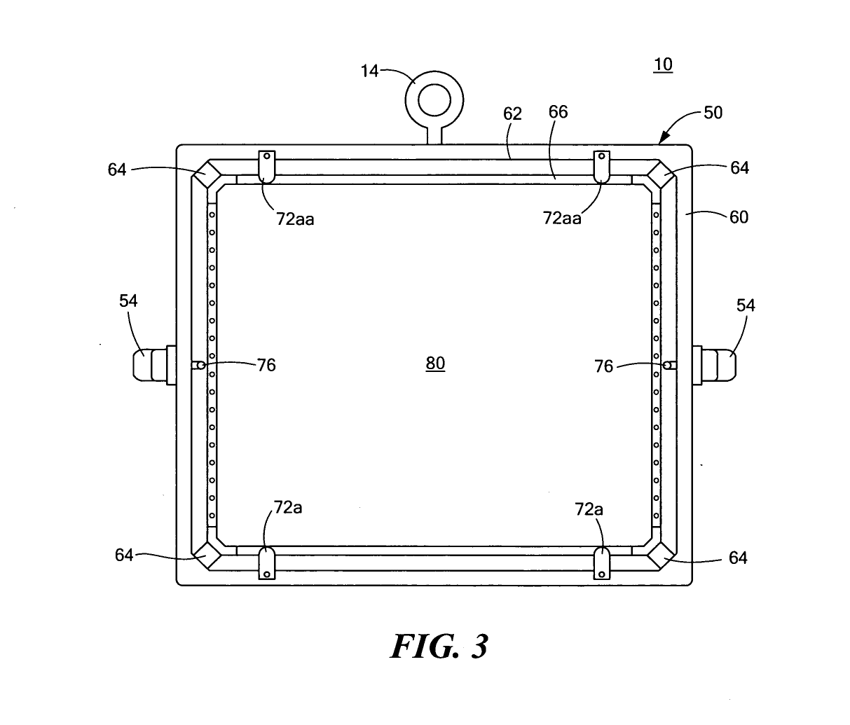

Transit case system 10, FIGS. 2 and 3, may include transit case 50 which contains a lifting device, such as eye 14 on its top which engages with a hook or other device 52 connected to chain 16 for lifting. In addition, or as an alternative, transit case 50 may be provided with other lifting devices, such as handles 54 two on each side for lifting via personnel. Transit case 50 may include a housing 60 on the outside and on the inside a fixed rack 62 which is fixed to housing 60 by means of resilient mountings, such as rubber or springs 64 which act to isolate the electronic equipment inside from shock and vibration.

Inside of fixed rack 62 is sliding rack 66 which is bi-directionally slidable toward the front arrow 68 and toward the back arrow 70 in the direction of receiver rack 20. Although not shown, fixed rack 62 and/or sliding rack 66 can include sliding facilitators to facilitate the bi-directional slidability. For example, either rack can include the use of special coatings (e.g., Teflon or hard coat anodize), strips of polymer (e.g., acetal, nylon) over a portion of or the entire bearing surface, and/or lubricants (oils, grease). Either rack could also include built-in rollers, bushings, and/or bearings. These rollers, bushings, and/or bearings can be made of Delrina, Torlon, or similar polymer. Any of the sliding facilitators can located in or on the load bearing surface indicated as 64 or elsewhere in or on either rack. These sliding facilitators can also be located in or on slide brackets 41.

Pivoting or rotatable stops 72 may be provided on housing 60 or fixed rack 62 to prevent sliding rack 66 from moving forward as indicated in the direction of arrow 68. Guide members such as pins 76 are provided to align transit case system 10 with any particular bay and slot of receiver rack 20, in this case slot 36 of bay 30. Guide member pins 76 may be fixed to housing 60 of transit case 50 or to fixed rack 62 and may engage with alignment holes 78 in vertical supports 22 of receiver rack 20. Alternatively, pins 76 may be on vertical supports 22 and the holes may be in housing 60 or fixed rack 62 or any other similar type of guiding device may be used. The space 80 is typically filled with racks of electronic equipment mounted to sliding rack 66 to be cartridge loaded out the back of transit system 10 into a slot of a bay of the receiver rack 20. There may be similar stops 72a, FIG. 3, on the bottom of transit case system 10 and also on the top 72aa, if desired, and there may also be stops in the upper position at the front of transit case system 10 which are shown in phantom in FIG. 2.

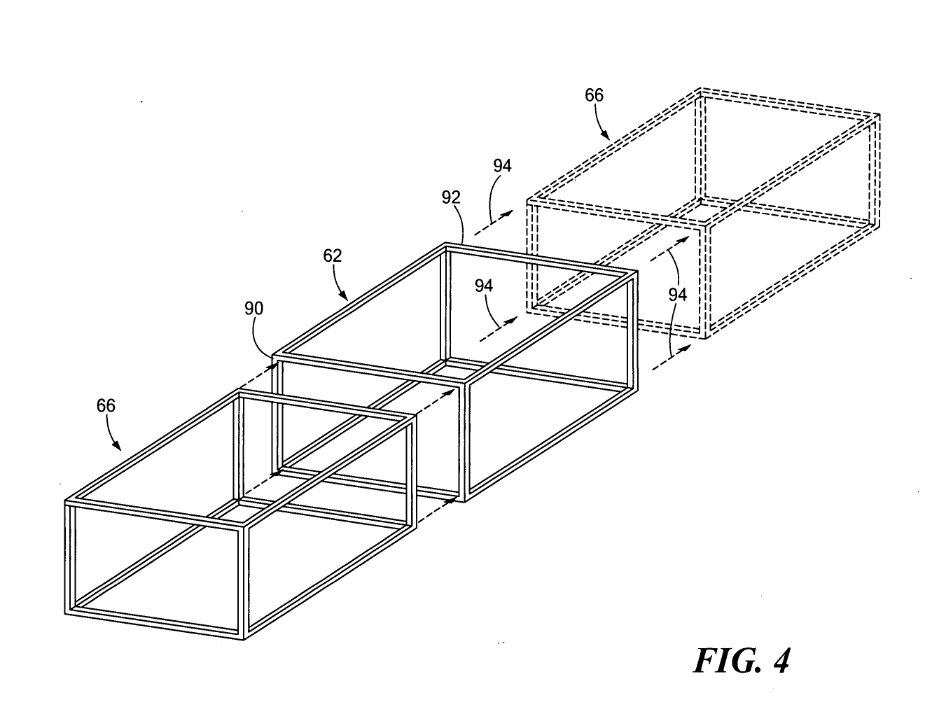

The conventional structure of the fixed rack 62 and slidable rack 66 is shown in FIG. 4 where they are in the simplest rendition, merely three dimensional frames constructed so that sliding rack 66 can slide into and reside in fixed rack 62. However, in accordance with this invention the design is such that the sliding rack 66 cannot only enter the front 90 of fixed rack 62 but it can exit the back 92 of fixed rack 62 as indicated by phantom arrowed lines 94, so that the sliding rack 66 complete with its electronic modules can be loaded into a selected slot of a bay of the receiver rack using a cartridge-type-loading operation.

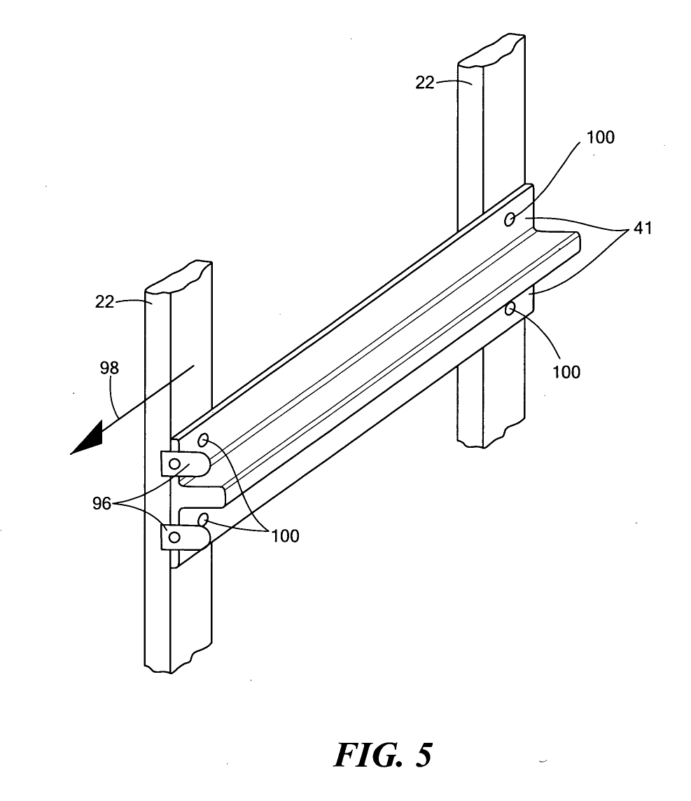

Slide brackets 41 are shown in more detail in FIG. 5 where they are formed of “L” shape channel mounted by bolts 100 to vertical supports 22. Pivoting or rotatable stop members 96 may be used to arrest movement in the forward direction as indicated by arrow 98 on receiver rack 20. In the illustrated embodiment, there are no stops at the back end of slide brackets 41 because rack 20 might be located close to or against a wall. However, in other embodiments not shown, pivoting or rotatable stop members 96, or permanent, non-rotatable stop members, may be used to arrest movement in the reverse direction opposite the direction indicated by arrow 98.

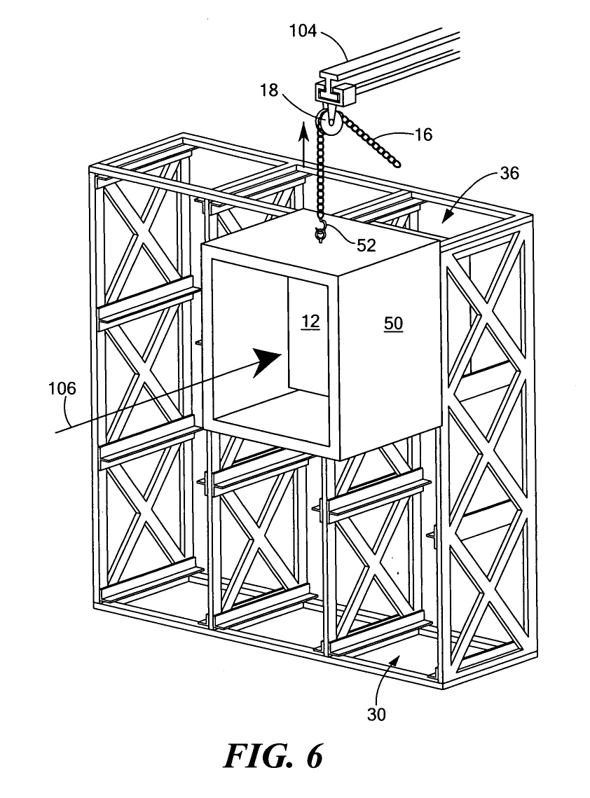

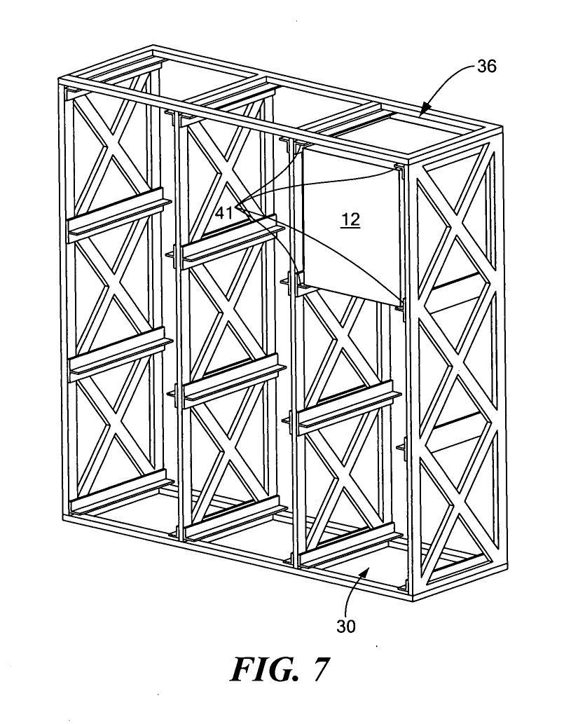

In operation, referring to FIGS. 1, 2, 6 and 7, the transit case system 10 is raised using eye 14, chain 16, and chain hoist 18 supported by beam 104, for example, to a position adjacent the selected slot, e.g. 36, of bay 30 and held there while the alignment pins 76 are engaged with the holes 78 on receiver rack 20. Advantageously with this system, the raising and alignment can be done by one person. And, as shown in FIG. 6 only one person is needed to push in the direction of arrow 106 to move module 12 through and out of transit case 50 and into slot 36 of bay 30. If personnel are available for a man lift, a chain hoist 102 need not be used to accomplish the lifting. Finally, FIG. 7, module 12 with sliding rack 66 is completely loaded in slot 36 of bay 30 nested between four slide brackets 41.

The invention also contemplates a method for loading into a receiver rack an electronic rack stored in a transit case as explained with reference to FIGS. 1-7 by aligning a front side of the transit case with a modular slot of the receiver rack and sliding a slidable sliding rack out of the transit case and into the modular slot by exerting a force from the rear side of the transit case. Lifting may involve using a lifting device such as a simple machine e.g., a pulley. Aligning may be achieved by properly aligning alignment pins.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A cartridge-type-loading transit case system for loading electronic racks in a receiver rack comprising:
a transit case;
a fixed rack mounted in said transit case; and
a sliding rack bi-directionally slidable in forward and back directions in said fixed rack for engaging a receiver rack into which said sliding rack is to be back loaded from said transit case.

2. The cartridge-type-loading transit case system of claim 1 further including at least one guide member for engaging a receiver rack.

3. The cartridge-type-loading transit case system of claim 2 in which said at least one guide member is mounted on said transit case.

4. The cartridge-type-loading transit case system of claim 3 in which said at least one guide member includes a pin on one of said transit case and receiver rack and a hole on the other.

5. The cartridge-type-loading transit case system of claim 1 further including a stop member for constraining sliding movement of said sliding rack in said transit case.

6. The cartridge-type-loading transit case system of claim 5 in which there are stop members at the back and front of said transit case.

7. The cartridge-type-loading transit case system of claim 6 in which said stop members are mounted on said transit case.

8. The cartridge-type-loading transit case system of claim 1 in which said transit case includes a lifting device for raising it to the proper height and alignment with said receiver rack.

9. A cartridge-type-loading transit case system for loading electronic racks in a receiver rack comprising:
a transit case;
a fixed rack mounted in said transit case;
a sliding rack bi-directionally slidable in forward and back directions in said fixed rack; and
a receiver rack for receiving said sliding rack loaded from said transit case.

10. The cartridge-type-loading transit case system of claim 9 further including at least one guide member for engaging said receiver rack.

11. The cartridge-type-loading transit case system of claim 10 in which said at least one guide member is mounted on said transit case.

12. The cartridge-type-loading transit case system of claim 11 in which said at least one guide member includes a pin on one of said transit case and said receiver rack and a hole on the other.

13. The cartridge-type-loading transit case system of claim 9 further including a stop member for constraining sliding movement of said sliding rack in said transit case.

14. The cartridge-type-loading transit case system of claim 13 in which there are stop members at the back and front of said transit case.

15. The cartridge-type-loading transit case system of claim 14 in which said stop members are mounted on said transit case.

16. The cartridge-type-loading transit case system of claim 9 in which said transit case includes a lifting device for raising it to the proper height and alignment with said receiver rack.

17. A method for loading an electronic rack stored in a transit case into a receiver rack comprising:
aligning a front side of the transit case with a modular slot of the receiver rack; and
sliding a slidable sliding rack out of the transit case and into the modular slot by exerting a force from a rear side of the transit case, said rear side being opposite said front side.

18. The method of claim 17 in which aligning further includes lifting the transit case using a lifting device of the transit case.

19. The method of claim 18 in which lifting includes lifting the transit case using a simple machine.

20. The method of claim 17 in which aligning includes aligning an alignment pin with a corresponding alignment hole.
